(19) United States
(12) Patent Application Publication
(10) Pub. No.: US 2025/0308825 A1
(43) Pub. Date: Oct. 2, 2025

(54) CONTROL UNIT FOR AN ELECTRICAL CIRCUIT BREAKER AND ASSOCIATED ELECTRICAL CIRCUIT BREAKER

(71) Applicant: Schneider Electric Industries SAS, Rueil-Malmaison (FR)

(72) Inventors: Thomas Bianchi, Grenoble (FR); Patrick Prieur, Claix (FR); Yves Leveque, Voiron (FR)

(73) Assignee: Schneider Electric Industries SAS, Rueil-Malmaison (FR)

(21) Appl. No.: 19/090,660

(22) Filed: Mar. 26, 2025

(30) Foreign Application Priority Data
Mar. 28, 2024 (FR) 2403193

(51) Int. Cl. H01H 71/02

(52) U.S. Cl. CPC H01H 71/0228

(57) ABSTRACT

This control unit (20) presents a front face (22) extending on a front plane (P22) where at least one housing (201; 301; 401) configured to receive a functional module (200; 300; 400) in an assembled position opens. Contact pads (36) are arranged at the bottom of each housing recessed from the front plane, so that a clearance distance between each contact pad and the front plane is greater than a class 2 isolation distance under a voltage greater than 690 V. In the assembled position, each functional module at least partially closes the corresponding housing, so that a creepage distance between each contact pad and the front plane is greater than a class 1 isolation distance under a voltage less than or equal to 690 V.

The present invention relates to a control unit for an electrical circuit breaker, as well as an electrical circuit breaker comprising such a control unit.

It is known, particularly from EP-0 843 332-A1, electrical circuit breakers including a breaker unit and an electronic control unit. Such a control unit is typically configured to measure, in real-time, the operating state of the circuit breaker and to command the opening of the breaker unit in case of a malfunction of the circuit breaker. The control unit is reversibly received in a housing provided in the breaker unit and is located on a front face of the circuit breaker, so that a user can read and/or adjust certain operating parameters of the electrical circuit breaker. The control unit is removable, so that a user can replace the control unit in case of malfunction, without having to disconnect the breaker unit from the rest of the electrical installation.

According to the applications, the electrical circuit breaker operates under voltages of several hundred or even thousands of Volts, and under currents up to several thousand Amperes. The electrical circuit breaker in general, and the control unit in particular, must present sufficient electrical isolation to ensure the safety of people. For example, the IEC 947-1:2019 standard—tables 13 and 15—defines isolation classes, which correspond to minimum distances to be respected between electrified points—or likely to be electrified—and the user. The isolation distances depend, in particular, on the isolation class sought, and the electrical voltage under which the electrical circuit breaker operates. In the context of the present description, two main voltage ranges are considered, with a first range corresponding to a voltage less than or equal to 690 V, and a second range corresponding to a voltage strictly greater than 690 V. For a voltage greater than 690 V, class 1 isolation requires an air distance greater than 7 mm, and creepage distances greater than 10 mm. Class 2 isolation doubles these distances. For a voltage less than 690 V, class 2 isolation requires an air distance greater than 10 mm. In English, the air distance is also called “clearance distance.”

EP 3 290 935-A1 describes, for example, a control unit comprising a casing made of an insulating material, in which several components are received, such as a printed circuit board, voltage division components, etc. A power module is generally provided to power the control unit when the circuit breaker is energized. A battery is generally provided and received in a housing provided in the casing, in particular to allow the backup of various data during the triggering of the circuit breaker or when the circuit breaker is not energized.

However, this battery must be changed periodically. With prior art electrical circuit breakers, it is necessary to remove the control unit from the breaker unit, which requires the user to have specific authorization and to interrupt the service of the electrical installation, making the replacement of a battery, an apparently simple task, a heavy and complex operation. Thus, it is sought to be able to change the battery from the front, without interruption of service, while ensuring the safety of people.

With the evolution of technologies and needs, it is advantageous to propose, if necessary, communication interfaces, wired or wireless, so that the user can transfer data from and/or to the control unit. It is known to connect modules to control units, however, to ensure isolation distances, these connections are generally made from the back of the control units, which requires removing the control unit from the breaker unit, and/or by means of functional modules that include electrical protection devices and are then too bulky to fit inside existing control units.

The invention particularly aims to address these needs by proposing a control unit that allows the easy installation of functional modules, while ensuring the protection of people and remaining compact.

To this end, the invention relates to a control unit for an electrical circuit breaker, the control unit comprising:
a front face, which presents a generally flat shape and is geometrically carried by a front plane, the front face being orthogonal to a depth axis and defining a forward direction oriented toward the user when the control unit is in a normal use configuration,
a casing, which is made of an insulating material and in which at least one housing is provided, each housing being provided recessed from the front plane and opening onto the front face,
a printed circuit board, which comprises at least one connection zone, each connection zone comprising one or more electrical contact pads and being associated with a respective housing,
at least one functional module, each housing being associated with a respective functional module, each functional module comprising an envelope, which is made of an electrically insulating material and which delimits a cavity, each functional module being configured to be reversibly received in the associated housing, the functional module being in an assembled configuration,
   wherein, for each housing:
each contact pad of the associated connection zone is located recessed from the front plane and is spaced away from the front plane by a distance, measured according to the depth axis, greater than a predetermined first threshold,
the first threshold is chosen so that a clearance distance between each contact pad and the front plane is greater than a class 2 isolation distance under a voltage greater than 690 V, the clearance distance and the class 2 isolation distance being according to the IEC 947-1:2019 standard, and
when the functional module is received in the corresponding housing, the envelope at least partially closes the associated housing, so that a creepage distance between each contact pad and the front plane is greater than a class 1 isolation distance under a voltage less than 690 V, the creepage distance being according to the IEC 947-1:2019 standard.

Thanks to the invention, various functional modules can be easily installed from the front of the control unit, without having to remove the control unit from the breaker unit. The electrical contact pads are all arranged recessed from the front face, which ensures a sufficient isolation distance, whether the functional modules are present or not. Once installed, the functional modules do not increase the footprint of the control unit, which thus remains compact.

According to advantageous but non-mandatory aspects of the invention, such a control unit may incorporate one or more of the following features taken in isolation or in any technically permissible combination:
The first threshold is greater than or equal to 14 mm.
Each envelope comprises a proximal wall, which is generally orthogonal to a main axis, and a peripheral wall, which extends in projection from the proximal wall, and which presents a continuous contour around the main axis, the proximal wall and the peripheral wall together delimiting the cavity of the envelope, the cavity opening from the envelope through a distal opening, which is located opposite the proximal wall according to the main axis,
   whereas, when the functional module is in an assembled configuration:
the main axis is parallel to the depth axis, while the distal opening is oriented toward the corresponding connection zone, the cavity masking the contact pads according to the depth axis,
a creepage distance from each contact pad to the front plane is greater than a predetermined second threshold, the second threshold being greater than the first threshold.
The second threshold is greater than a class 2 isolation distance under a voltage greater than 690 V as defined in the IEC 947-1:2019 standard.
The second threshold is equal to 20 mm.
The at least one housing is delimited, on the rear side, by a bottom wall, which is part of the casing, which is arranged recessed relative to the front plane according to the forward direction and in which openings are provided, the openings opening into the housing, while the contact pads of the connection zone associated with the housing are located on a rear side of the bottom wall and are accessible from the housing through the openings.
Each opening presents a profile with an inscribed circle diameter strictly less than 4 mm, in order to comply with an IP2x protection index as defined in the IEC 60529:2013 standard.
The casing comprises an intermediate wall, which is generally parallel to the front plane, and which is arranged recessed from the front plane, the printed circuit board being located on a rear side of the intermediate wall, while for the at least one housing, the corresponding bottom wall is a portion of the intermediate wall.
Each functional module comprises at least one complementary contact, which is made of metal, which is partially received in the corresponding cavity, and which protrudes outside the cavity,
while each complementary contact is configured to be reversibly connected to a respective electrical contact pad associated with the corresponding housing when the functional module is in an assembled configuration.
Each functional module is chosen from a list including a battery module, a wireless communication module, and a wired connection module.
The control unit comprises three functional modules, which are each associated with a respective housing,
while the three functional modules are different from each other and include a battery module, a wireless communication module, and a wired connection module.

The invention also relates to an electrical circuit breaker, comprising:
a breaker unit, comprising at least one breaker device and an actuator, the breaker device being triggerable by means of the actuator,
an example of the control unit such as defined above,
in which:
   the breaker unit provides a receptacle, which opens onto a front face of the breaking unit,
   the control unit is received in the receptacle of the breaking unit, so that the front face of the control unit is substantially aligned with the front face of the breaking unit.

Advantageously:
the circuit breaker comprises a cover, which is reversibly fixed on the breaker unit, which is made of an electrically insulating material, which extends generally according to a frontal plane, and which delimits a portion of the frontal face,
the at least one housing of the control unit includes a frontal housing, which is arranged at the edge of the front face, while the corresponding functional module envelope presents a recess, which is located recessed from the front plane,
when the control unit is received in the receptacle of the breaker unit and the cover is mounted on the breaker unit, the cover at least partially covers the recess, so as to prevent the removal of the functional module associated with the frontal housing.

The invention will be better understood, and other advantages thereof will appear more clearly in the light of the following description of one embodiment of a control unit and an electrical circuit breaker, in accordance with its principle, given solely by way of example and made with reference to the appended drawings, in which:

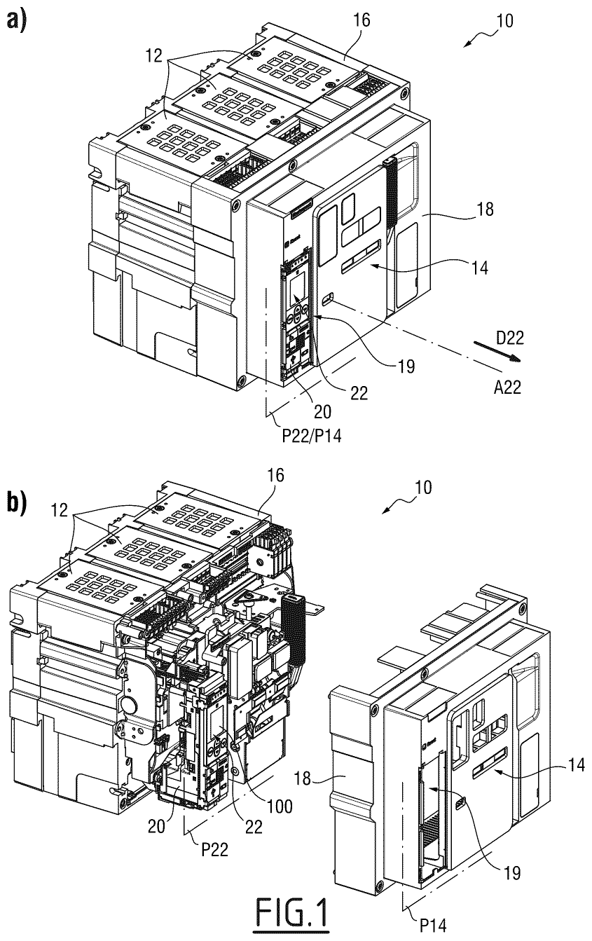

FIG. 1 respectively represents, in two inserts a) and b), a perspective view and a partially exploded perspective view of an electrical circuit breaker in accordance with the invention, the electrical circuit breaker comprising a control unit, also in accordance with the invention;

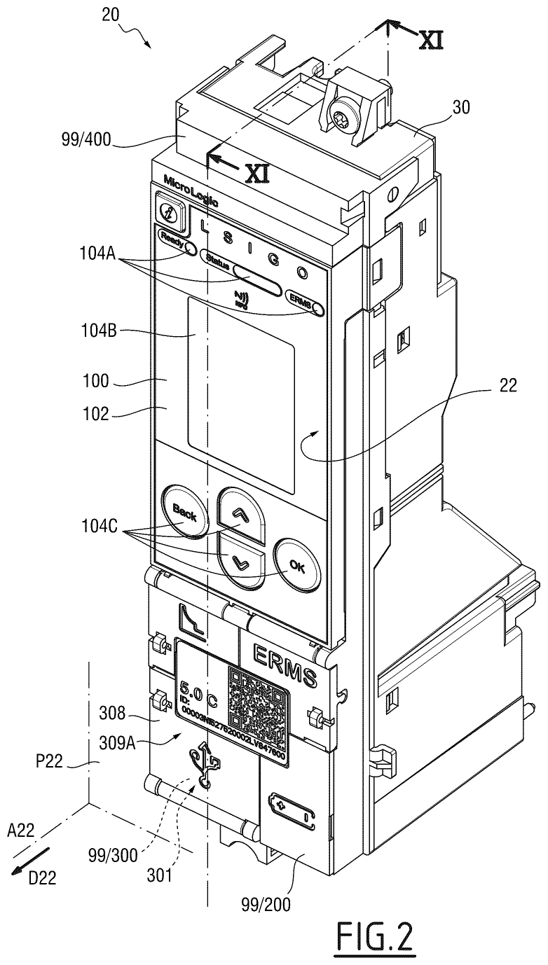

FIG. 2 is a perspective view of the control unit of FIG. 1;

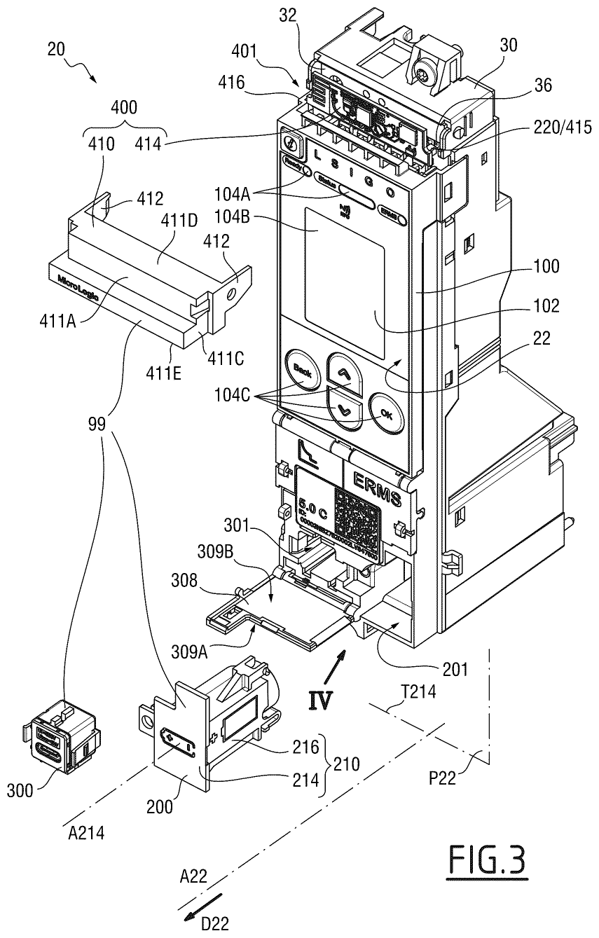

FIG. 3 is a partially exploded perspective view of the control unit of FIG. 1, the control unit comprising a battery module, a wired connection module, and a wireless communication module;

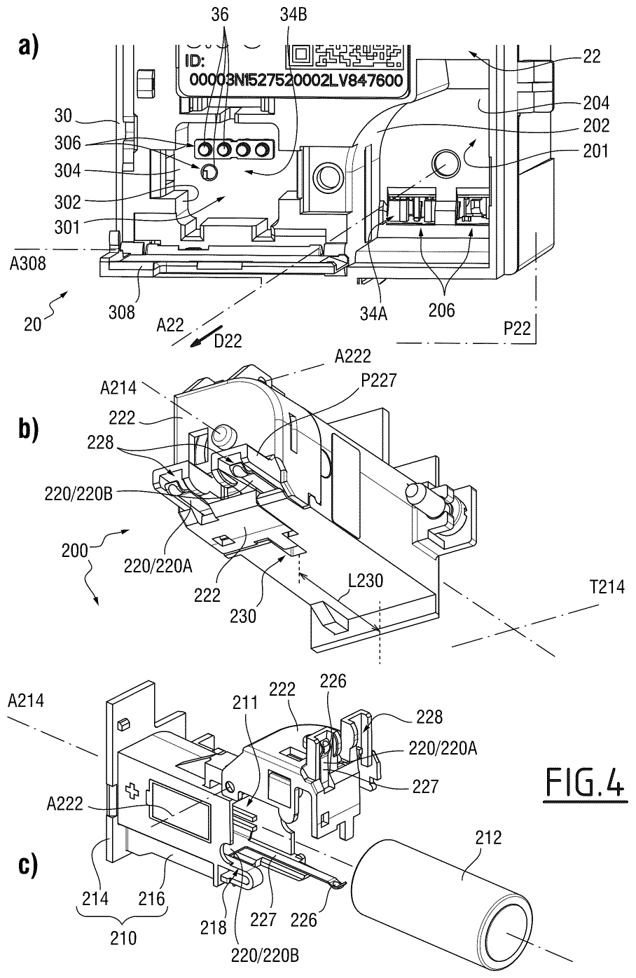

FIG. 4 respectively represents, in three inserts a), b), and c), a larger scale view of the control unit according to the arrow IV in FIG. 3, and the battery module of FIG. 3, the battery module being represented in two different configurations in inserts b) and c);

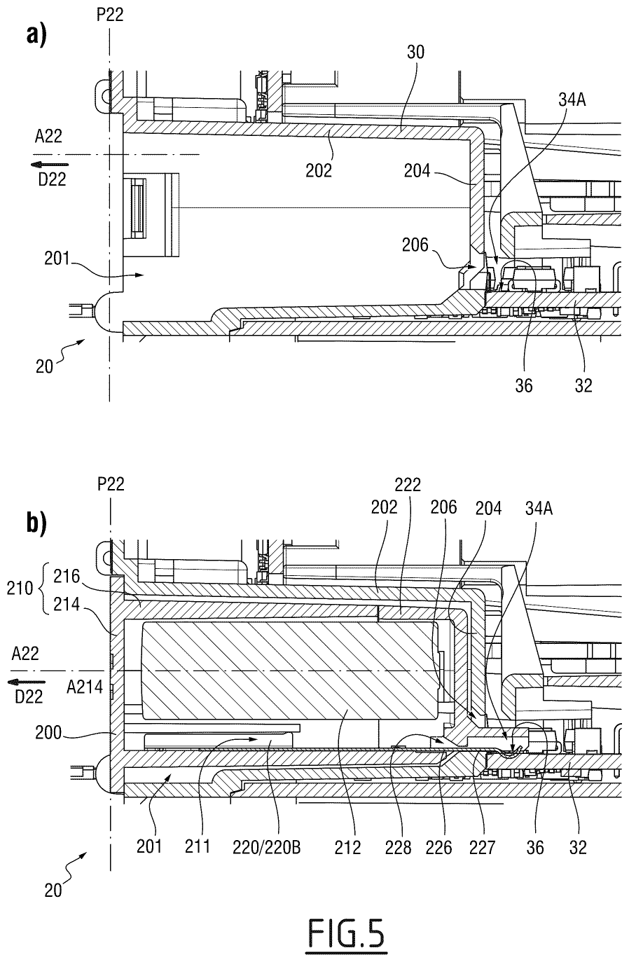

FIG. 5 represents, in two inserts a) and b), a section of a housing provided in the control unit and configured to receive the battery module, the control unit being represented in two different configurations;

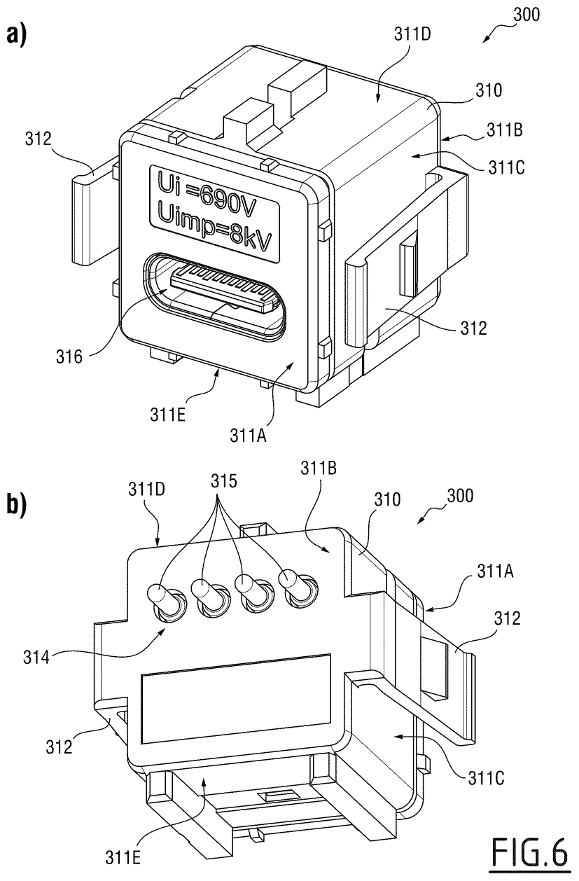

FIG. 6 represents, in two inserts a) and b), a perspective view of the wired connection module of FIG. 3, observed according to two different angles;

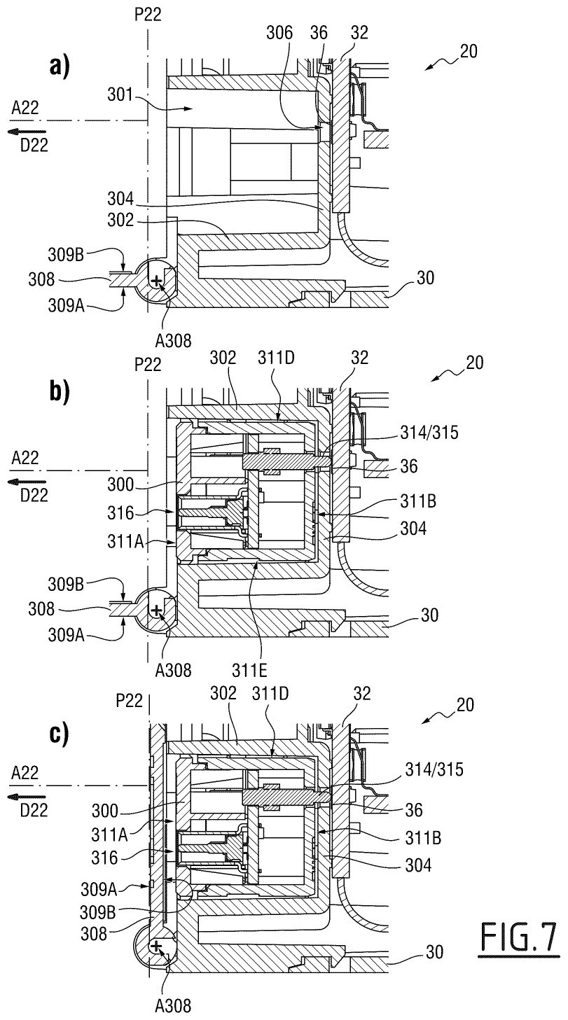

FIG. 7 represents, in three inserts a), b), and c), a section of a housing provided in the control unit and configured to receive the wired connection module, the control unit being represented in three different configurations;

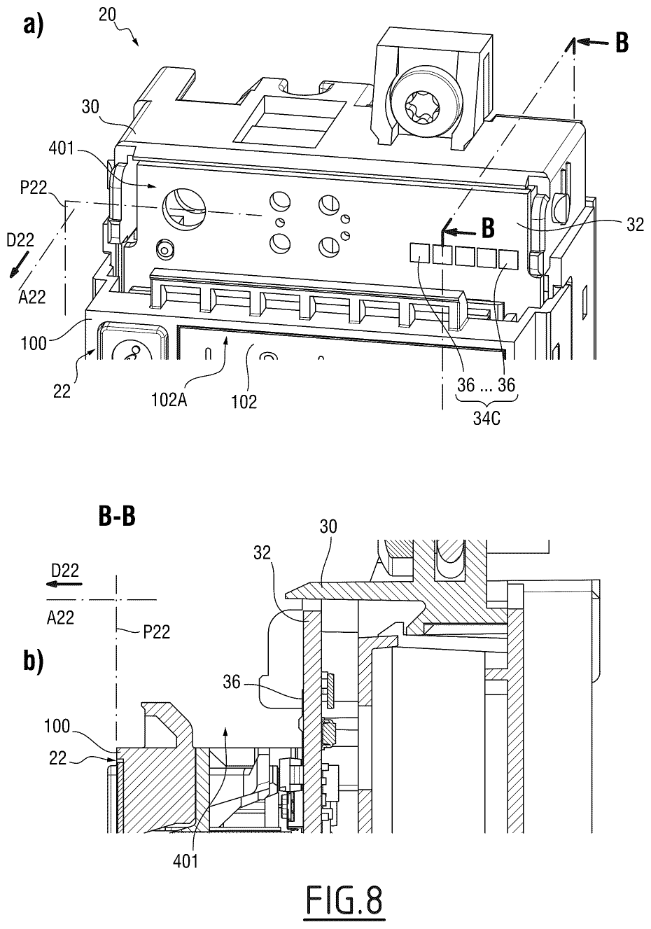

FIG. 8 represents, in two inserts a) and b), a larger scale view of the control unit of FIG. 3, some pieces being hidden, and a section of the control unit, according to a plane B-B in insert a);

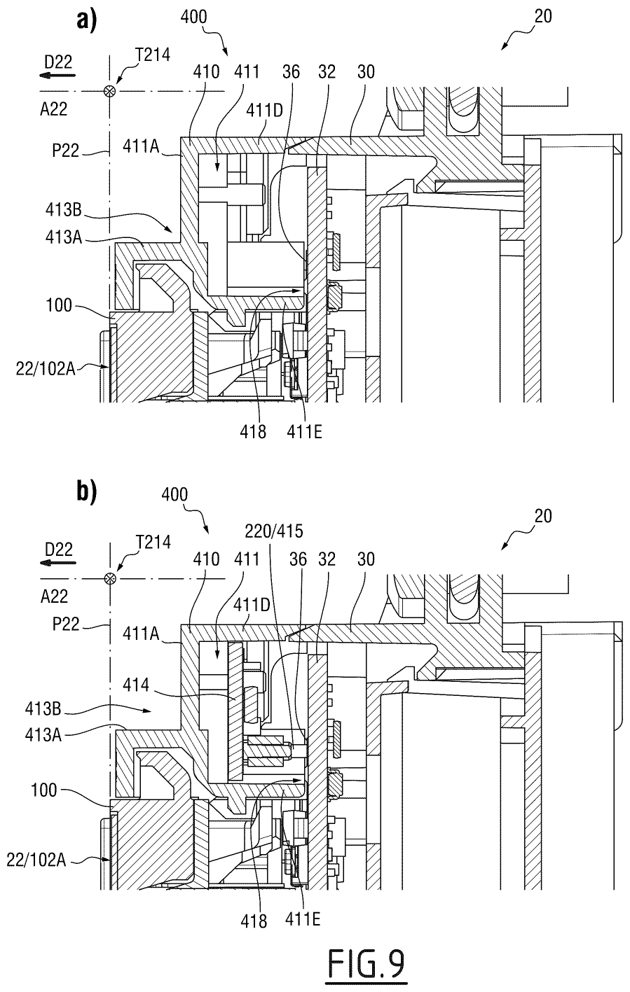

FIG. 9 respectively represents, in two inserts a) and b), a section of the control unit according to the plane B-B, the control unit being represented in two different configurations;

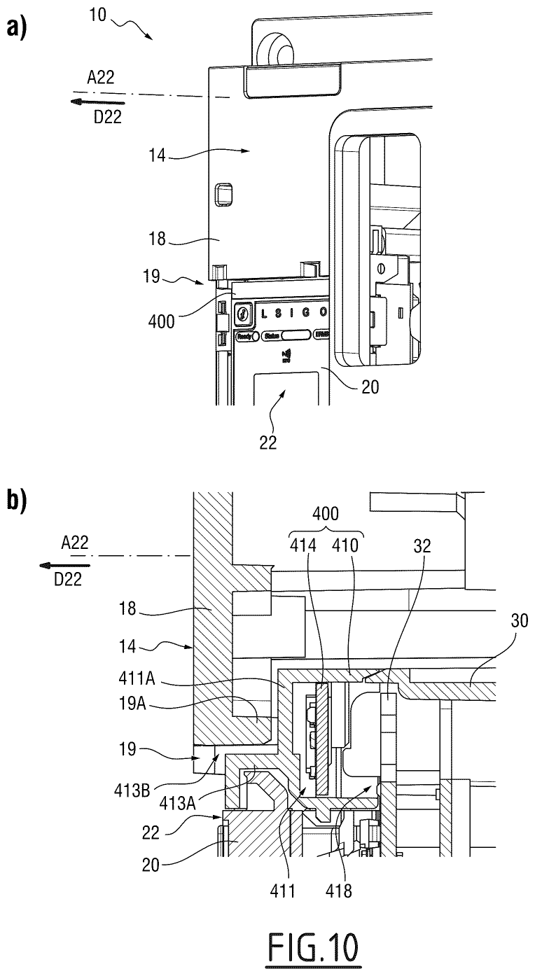

FIG. 10 respectively represents, in two inserts a) and b), a perspective view and a section of the electrical circuit breaker of FIG. 1, some pieces being hidden, and

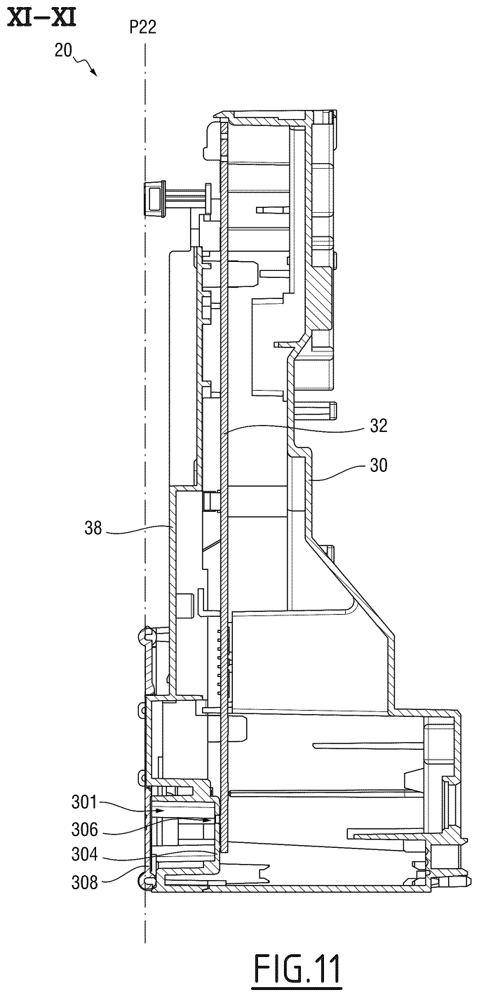

FIG. 11 is a section, according to a plane XI-XI, of the control unit of FIG. 2.

An electrical circuit breaker 10 is represented in FIG. 1. The electrical circuit breaker 10, also simply called circuit breaker 10, is here a multipole circuit breaker, in particular a three pole circuit breaker. The number of poles of the circuit breaker 10 is not limiting. In a known manner, a multipole electrical circuit breaker includes, for each electrical pole, input, and output power terminals, which are respectively connected or electrically isolated from each other by a breaker device of the circuit breaker. The breaker device comprises, for example, separable movable contacts, which are received in a breaker chamber of the electrical circuit breaker 10 and the movements of which are controlled by an actuator. Thus, the breaker device is triggerable by the actuator. The breaker chambers are here materialized by three grids 12 visible on an upper face of the circuit breaker 10, the other elements of the breaker device not being represented.

The electrical circuit breaker 10 is intended to be used within an electrical installation, for example to control the power supply of a machine tool. In a normal use configuration, the electrical circuit breaker 10 is generally placed within an electrical cabinet, the electrical circuit breaker 10 presenting a front face 14, which is oriented toward the user standing in front of the electrical cabinet. The electrical cabinet is not represented.

The electrical circuit breaker 10 comprises a breaker unit 16, which in particular includes each of the breaker chambers, as well as the breaker device and the associated actuator.

The electrical circuit breaker 10 advantageously comprises a cover 18, which is reversibly fixed on the breaker unit 16. The cover 18 is made of an electrically insulating material and extends generally according to a frontal plane P14, which delimits a portion of the frontal face 14 of the electrical circuit breaker 10, and by extension of the breaker unit 16. The cover 18 thus serves to protect the user from the circuit breaker 10. In FIG. 1 a), the cover 18 is represented assembled to the breaker unit 16, which corresponds to a normal use configuration of the circuit breaker 10. In FIG. 1 b), the cover 18 is spaced away from the breaker unit 16, this configuration being found, for example, during maintenance of the breaker unit 16. The cover 18 comprises a window 19, through which the front face 22 of the control unit 20 is visible. The window 19 is preferably closed by a transparent flap. The flap is not represented.

The electrical circuit breaker 10 also comprises a control unit 20. The control unit 20 is configured to analyze the states of the breaker unit 16 and is configured to trigger the actuator based on the results of these analyses, thus separating the separable contacts.

The control unit 20 comprises a front face 22. The front face 22 presents a generally flat shape and is geometrically carried by a front plane P22, which is orthogonal to a depth axis A22 of the control unit 20. The front face 22 is oriented toward the user when the control unit 20 is in a normal use configuration. The front face 22 thus defines a forward direction D22, which is parallel to the depth axis A22. The forward direction D22 is represented by an arrow. The notions of directions such as “forward,” “backward,” “up,” “down,” etc., are defined in relation to the elements such as represented in the drawings, knowing that it may be otherwise in reality.

The cover 18 comprises a window 19, through which the front face 22 of the breaking unit 20 is visible. The window 19 is preferably closed by a transparent flap. The flap is not represented.

The control unit 20 is assembled to the breaker unit 16 in a reversible manner. In the example of FIGS. 1a) and 1b), the control unit 20 is represented in an assembled configuration to the breaker unit 16. The control unit 20 is represented in isolation in FIG. 2.

The breaker unit 16 provides a receptacle, which opens onto a frontal face 14 of the breaker unit 16 and in which the control unit 20 is received, so that the front face 22 of the control unit 20 is substantially aligned with the frontal face 14 of the breaker unit 16, as illustrated in particular in FIG. 1 a). The receptacle is not represented.

The control unit 20 is now described, with reference to FIGS. 2 and 3.

The control unit 20 comprises a casing 30, which is made of an insulating material, and which forms a receiving volume for various components of the control unit 20. The casing 30, in particular, houses a printed circuit board 32, which is partially visible in FIG. 3. The printed circuit board 32 comprises a printed circuit and several electronic components such as a microprocessor, a light-emitting diode, etc.

In the illustrated example, the printed circuit board 32 comprises several portions, which are, here, connected to each other by a communication bus. The communication buses are not represented. Optionally, one or more portions of the printed circuit board 32 are flexible. Alternatively, the printed circuit board 32 includes several portions that are not connected to each other by the communication buses. Alternatively, the printed circuit board 32 is in one piece.

The casing 30 includes a front sub-assembly 100. By extension, the sub-assembly 100 belongs to the control unit 20. The front sub-assembly 100 comprises a central portion 102, which is generally flat, which presents a front side 102A and a rear side 102B opposite the front side 102A. The central portion 102 is here configured to receive at least one human machine interface element 104. The front side 102A of the central portion 102 is preferably oriented according to the forward direction D22. A human machine interface is also referred to by its acronym HMI. The human machine interface elements 104 are also simply noted as “HMI elements” 104. In the illustrated example, the central portion 102 comprises several HMI elements 104. The HMI elements 104 here include three indicator lights 104A, a transparent portion 104B, through which a screen can be observed, and four buttons 104C. These examples are not limiting, the type, number, and arrangement of the HMI elements 104 can be changed during the design of the front sub-assembly 100.

The front sub-assembly 100 is assembled to the rest of the control unit 20, in particular to the casing 30, in a reversible manner. It is thus possible to replace the front sub-assembly 100 in case of malfunction. The central portion 102 thus forms a portion of the front face 22 of the control unit 120.

The casing 30 comprises at least one housing 98, here three housings, each housing being provided recessed from the front plane P22 and opening onto the front face 22.

The control unit 20 also comprises at least one functional module 99, here three functional modules 99, each housing being associated with a respective functional module. Each functional module 99 is thus configured to be reversibly received in the associated housing, the functional module 99 under consideration, being in an assembled configuration.

Preferably, the control unit 20 comprises several functional modules 99. In the illustrated example, the control unit 20 comprises three functional modules 99, which are different from each other, and which include a first module 200, which is here a battery module, a second module 300, which is here a wired connection module, and a third module 400, which is here a wireless communication module. Each functional module 99 is associated with a respective housing 98. Each functional module 99 is configured to be reversibly received in the associated housing 98, the functional module 99 being then in an assembled configuration. In the illustrated example, each functional module 99 is configured to be inserted into the corresponding housing 98 according to an insertion movement, which is a movement in translation, parallel to the depth axis A22 and oriented according to a rearward direction, in other words, in a direction opposite to the forward direction D22.

In FIG. 3, the control unit 20 is represented in a partially exploded perspective, the first battery module 200, the second connection module 300, and the third communication module 400 being represented spaced away from the housing. The first battery module 200 is thus associated with a battery housing 201, while the second connection module 300 is associated with a connection housing 301, and the third communication module 400 is associated with a housing arranged at the edge of the front face 22 and named frontal housing 401. In the illustrated example, the control unit 20 comprises a cover 308, which is articulated relative to the casing, and which closes the connection housing 301. The cover 308 is represented in a closed position in FIG. 2, and in an open position in FIG. 3.

The first battery module 200 and the associated battery housing 201 are now described.

With reference to FIG. 4 a), the battery housing 201 presents a substantially cylindrical shape according to an axis parallel to the depth axis A22. The battery housing 201 is here delimited by a peripheral wall 202 and by a bottom wall 204. The bottom wall 204 delimits the battery housing 201 on the rear side and is part of the casing 30. The bottom wall 204 is thus arranged recessed from the front plane P22 according to the forward direction D22 and opens onto the front plane P22.

The battery housing 201 comprises openings 206, which are provided in the bottom wall 204 and which open into the battery housing 201. A portion of the printed circuit board 32 is located on the rear side of the bottom wall and comprises a first connection zone 34A, the first connection zone 34A comprising at least one contact pad 36. Each contact pad 36 comprises a substantially flat conductive element located on the surface of the printed circuit board 32, each contact pad 36 being able to be electrically connected to a respective complementary connector 220 belonging to the functional module 99 associated with the housing 98, under consideration, here the first battery module 200, each complementary connector 220 coming into contact with the corresponding contact pad 36. Advantageously, the contact pads 36 are part of the printed circuit of the printed circuit board 32, in other words, they are manufactured at the same time as the printed circuit board 32.

In the illustrated example, the first connection zone 34A comprises two contact pads 36, which are located on the rear side of the bottom wall 204 and which are accessible from the battery housing 201 through the openings 206. The two contact pads 36, and by first extension the connection zone 34A, are thus associated with the first battery housing 201.

Each opening 206 presents a profile with an inscribed circle of diameter strictly less than 4 mm, preferably less than 3.9 mm, in order to comply with an IP2x protection index. The IP protection indices are defined in the IEC 60529:2013 standard. This thus reduces the risk of accidental introduction of objects through the openings, reducing the risk of electrical accidents.

Each contact pad 36 of the associated first connection zone 34A is located recessed from the front plane P22 and is spaced away from the front plane P22 by a distance, measured according to the depth axis A22, greater than a predetermined first threshold S1. The first threshold S1 is chosen so that a clearance distance between each contact pad 36 and the front plane P22 is greater than a class 2 isolation distance under a voltage greater than 690 V, the clearance distance and the class 2 isolation distance being according to the IEC947-1:2019 standard. Schematically, the clearance distance between two points is the shortest path between these two points, while bypassing any obstacles.

Preferably, the first threshold S1 is greater than or equal to 14 mm. Preferably, a clearance distance between the rear side of the bottom wall 204 and the front plane P22 is greater than the first threshold S1. This ensures a minimum distance between all electrified elements located on the rear side of the bottom wall 204 and the front face 22 of the control unit 20, which improves the safety of use.

The first battery module 200 is now described, in particular, with reference to FIGS. 4 b) and 4 c). The first module 200 comprises an envelope 210, which is made of an electrically insulating material, and which delimits a cavity 211. The cavity 211 is configured to receive an electric battery 212 presenting two electric poles. The electric battery 212 is here a cylindrical battery, the two electric poles of which are located on opposite faces.

The envelope 210 comprises a proximal wall 214, which is generally orthogonal to a main axis A214, and a peripheral wall 216, which extends in projection from the proximal wall, and which presents a continuous contour around the main axis A214, the proximal wall 214 and the peripheral wall 216 together delimiting the cavity 211. Once the first battery module 200 is received in the battery housing 201 in an assembled configuration, the main axis A214 is substantially parallel to the depth axis A22, as illustrated in FIG. 5 b). The cavity 211 opens from the envelope 210 through a distal opening 218, which is located opposite the proximal wall 214 according to the main axis A214.

When the first battery module 200 is received in the battery housing 201, the envelope 210 at least partially closes the battery housing 201, so that a creepage distance from each contact pad 36 to the front plane P22 is greater than a class 2 isolation distance under a voltage greater than 690 V, the creepage distance being according to the IEC 947-1:2019 standard.

When the first battery module 200 is in an assembled configuration, the distal opening 218 is advantageously oriented toward the corresponding first connection zone 34A, the cavity 211 masking, toward the front, the contact pads 36, so that a creepage distance from each contact pad 36 to the front plane P22 is greater than a predetermined second threshold S2, the second threshold S2 being greater than the first threshold S1. In a simplified manner, the creepage distance between two points is the minimum distance between these two points by traveling along the surface of the material, air gaps less than 1.5 mm can nevertheless be crossed in the air. Advantageously, the second threshold S2 is greater than a class 2 isolation distance as defined in the IEC 947-1:2019 standard. Preferably, the second threshold S2 is equal to 20 mm.

The first battery module 200 comprises, in addition to the insulating envelope 210, at least one complementary contact 220, which is made of an electrically conductive material, such as metal, which is partially received in the cavity 211 and which protrudes outside the envelope 210 through the distal opening 218. Each complementary contact 220 being configured to be reversibly connected to a respective contact pad 36 of the corresponding housing when the first battery module 200 is in an assembled configuration. Thus, the presence of electrical contacts, and more generally of any other electrical or electronic device received in the cavity, has no impact on the level of protection in terms of clearance distance or creepage distances.

In the illustrated example, the first battery module 200 comprises two complementary contacts 220, which connect the poles of the battery 212 to the contact pads 36 associated with the first battery housing 201. Advantageously, the first battery module 200 also comprises a cover 222, which is movable relative to the envelope 210 between an open position and a closed position, in which the cover 222 at least partially closes the cavity 211, the cover 222 in the closed position being configured to hold the electric battery 212 in the cavity, the first battery module 200 being then in a closed configuration.

The complementary contacts 220 include here a first conductive element 220A and a second conductive element 220B, which are formed by cutting and folding a metal sheet. The first conductive element 220A is, here, carried by the cover 222, while the second conductive element 220B is carried by the envelope 210.

The two conductive elements 220A and 220B each comprise an input tab, which is configured to be connected to a respective pole of the battery 212, and an output tab 226, which is configured to be connected to a respective electric contact pad 36 of the battery housing when the battery module is in a closed configuration and is received in the corresponding housing, in an assembled configuration of the battery module to the control unit, as represented in FIG. 5 b). The input tab is not represented in the present description. The output tab 226 here comprises a terminal portion 227 which here presents a straight blade shape, which advantageously ends with a spoon-shaped terminal bulge, configured to come into contact with the corresponding contact pad 36. The terminal portion 227 of each output tab 226 is advantageously elastically deformable, so as to ensure sufficient contact pressure between the curved end of the output tab 226 and the corresponding contact pad 36.

When the first battery module 200 is in a closed configuration, the two terminal portions 227 open from the cavity 211 through passages 228, which are provided in the cover 222. In the illustrated example, the two terminal portions 227 extend parallel to the main axis A214, the two terminal portions 227 being offset relative to each other according to a transverse axis T214, which is orthogonal to the main axis A214.

As illustrated in FIG. 4 c), the cover 222 is advantageously articulated in rotation relative to the envelope 210 around a hinge axis A222, between the open position and the closed position. The hinge axis A222 is here an axis parallel to the transverse axis T214. The cover 222 is thus considered non-detachable. During the mounting of the first battery module 200, the operator inserts the battery 212 into the cavity 211 of the envelope 201, of course respecting the direction of the poles, if necessary, then moves the cover 222 to the closed position, ensuring contact between each input tab and the corresponding pole of the battery 212.

The proximal wall 214 and the peripheral wall 216 together form a continuous portion of the envelope 210, the continuous portion extending to a minimum distance from the proximal wall 214, the minimum distance being measured according to the main axis and being equal to 14 mm. In other words, the proximal wall 214 and the peripheral wall 216 do not present any opening, which is located less than 14 mm according to the main axis A214, connecting the cavity 211 to the outside of the envelope.

In the illustrated example, the envelope 210 presents a notch 230, which is provided in the peripheral wall 216 and which delimits a portion of the distal opening 218, as represented in FIG. 4 b). The notch 230 is used here during the assembly of the second conductive element 220B in the envelope 210. A bottom of the notch here forms the place, through which the cavity 211 opens from the envelope 210, closest to the proximal wall 214. A distance L230, measured parallel to the main axis A214, is defined between the bottom of the notch 230 and the proximal wall 214. The distance L230 is greater than 14 mm. The distance L230 is here equal to 20.8 mm.

The second connection module 300, which is in accordance with an alternative embodiment of the invention, is now described. In alternative embodiments of the invention, elements similar to those of other embodiments bear the same references and operate in the same way. In the following, the differences between each embodiment and the previous one(s) are mainly described.

The connection housing 301 is represented in perspective in FIG. 4 a) and in section in FIG. 7. The second connection module 300 is represented in isolation in FIG. 6 and in an assembled configuration in FIGS. 7 b) and 7 c).

The connection housing 301 presents a substantially cylindrical shape according to an axis parallel to the depth axis A22. The connection housing 301 is here delimited by a peripheral wall 302 and by a bottom wall 304. The peripheral wall 302 delimits the connection housing 301 radially to the depth axis A22, while the bottom wall 304 delimits the connection housing 301 toward the rear. The peripheral wall 302 and the bottom wall 304 are, therefore, here part of the casing 30. The bottom wall 304 is thus arranged recessed relative to the front plane P22 according to the forward direction D22 and opens onto the front plane P22.

The connection housing 301 comprises openings 306, which are provided in the bottom wall 304 and which open into the battery housing 301. A portion of the printed circuit board 32 is located on the rear side of the bottom wall 304 and comprises a second connection zone 34B, the second connection zone 34B comprising at least one contact pad 36. The contact pads 36 of the second connection zone 34B are similar, or even identical, to the contact pads 36 of the first connection zone 34A.

In the illustrated example, the second connection zone 34B comprises five contact pads 36, which are located on the rear side of the bottom wall 304 and which are accessible from the connection housing 301 through the openings 306. The five contact pads 36, and by extension the second connection zone 34B, are thus associated with the second connection housing 301.

Each opening 306 presents a profile with an inscribed circle diameter strictly less than 4 mm, preferably less than 3.9 mm, in order to comply with an IP2x protection index according to the IEC 60529:2013 standard. In the illustrated example, for each of the openings 306, the diameter of the inscribed circle is substantially equal to 1.9 mm, even respecting an IP3x protection index. This thus reduces the risk of accidental introduction of objects through the openings, reducing the risk of electrical accidents.

The control unit 20 also comprises a cover 308, which is articulated relative to the rest of the control unit 20 and which is movable between a closed position, where the cover 308 closes the connection housing 301, and an open position, where the cover 308 does not close the connection housing 301. The cover 308 is here articulated in rotation relative to the casing 30 around a hinge axis A308 parallel to the front plane P22. The cover 308 is thus non-detachable. The cover 308 presents a generally flat shape and comprises a front face 309A and a rear face 309B, which is oriented opposite the front face 309A. When the cover 308 is in the closed position, the front face 309A is oriented according to the forward direction D22, while the rear face 309B is oriented towards the bottom wall 304.

Each contact pad 36 of the second connection zone 34B is located recessed from the front plane P22 and is spaced away from the front plane P22 by a distance such that, when the cover 308 is in the closed position, a clearance distance between each contact pad 36 and the plane 22 is greater than the predetermined first threshold S1.

The second connection module 300 is now described, with reference to FIG. 6.

The connection module 300 is configured to be received in the connection housing 301 in an assembled position of the connection module 300, the control unit 20 being then in an assembled configuration. The connection module 300 comprises a hollow body, which provides an envelope delimiting a cavity 311. The envelope 310 is made of an electrically insulating material. The envelope 310 here presents a generally parallelepiped shape and comprises a front side 311A, which is oriented toward the user when the connection module 300 is in the assembled position, and a rear side 311B, which is oriented opposite the side, in other words, which is located facing the second connection zone 34B when the control unit 20 is in the assembled configuration. The envelope 310 also comprises two lateral faces 311C, which are oriented opposite each other and which connect the front face 311A to the rear face 311B. The envelope 310 also comprises an upper face 311D and a lower face 311E, which are oriented opposite each other and which connect, on the one hand, the front face 311A to the rear face 311B and, on the other hand, the lateral faces 311C to each other.

The envelope 310 comprises attachment means 312 to hold the connection module 300 in the assembled position. The attachment means 312 are here two elastic clips, which extend from each of the lateral faces 311C. The attachment means 312 are advantageously reversible, so that a user can extract the connection module 300 from the connection housing 301, for example to replace the connection module 300 in case of malfunction.

The connection module 300 also comprises an input connector 314, which opens onto the rear side 311B, and which is configured to be connected to one or more of the contact pads 36 of the second connection zone 34B.

The input connector 314 advantageously comprises pins 315, preferably telescopic pins—also called “pogo-pins”, each pin 315 being configured to be connected to a respective contact pad 36 according to a movement in translation. The pins 315, and by extension the input connector 314, are an example of complementary contacts configured to be connected to a respective contact pad 36. Thus, the input connector 314, and the pins 315 in particular, protrude from the cavity 311. In the assembled configuration of the connection module 300, the rear face 311B is preferably in contact with the bottom wall 304. The telescopic pins 315 allow dimensional variations to be accommodated when the connection module 300 is in the assembled position. This thus reduces the footprint of the control unit 20, while ensuring good electrical contact between the input connector 314 and the associated contact pads 36. The pins 315 are an example of complementary contacts, which are received in the cavity 311.

The connection module 300 also comprises an output connector 316. The output connector 316 is connected to the input connector 314 through the envelope 310 and opens onto the front face of the envelope 310, the output connector 316 being able to receive a complementary connector so that a user can exchange data with the control unit 20. In the illustrated example, the output connector is advantageously in the so-called USB Type-C format. Other types of connectors are of course possible, as long as the space constraints are respected.

When the connection module 300 is in the assembled position, the cover 308 in the closed position prevents access to the output connector 316, the rear face 309B of the cover 308 being located facing the output connector 316.

The output connector 316 is located recessed from the front plane P22, so that when the cover 308 is in the closed position, the front face 309A is geometrically carried by the front plane P22. A creepage distance between the output connector 316 and the front plane P22 is greater than a class 1 isolation distance under a voltage less than or equal to 690 V, the creepage distance being according to the IEC 947-1:2019 standard. The creepage distance between the output connector 316 and the front plane P22 is thus greater than 10 mm. When the cover 308 is closed, a clearance distance between the output connector 316 and the front plane P22 is greater than a class 1 isolation distance under a voltage less than or equal to 690 V, the clearance distance being according to the IEC 947-1:2019 standard. The clearance distance between the output connector 316 and the front plane P22 is thus greater than 8 mm.

In the illustrated example, the creepage distance between the output connector 316 and the front plane P22 is equal to 10 mm, the cover 308 being closed, while the clearance distance is equal to 10 mm.

When the second connection module 300 is absent, a clearance distance between the contact pads 36 of the second connection zone 34B and the front plane P22 is greater than 14 mm, while a creepage distance between the contact pads 36 of the second connection zone 34B and the front plane P22 is greater than 20 mm, the cover 308 being in the closed position.

With reference to FIGS. 8 to 10, the third communication module 400, which is in accordance with one alternative embodiment of the invention, is now described.

The casing 30 delimits the communication housing 401, which is provided recessed from the front plane P22, and which opens onto the front face 22. In other words, the communication housing 401 is open according to the forward direction D22. In the illustrated example, the communication housing 401 is arranged at the edge of the front face 22, in other words, the communication housing 401 is also open according to a radial direction to the forward direction D22. In the illustrated example, the communication housing 401 is open toward the top of the control unit 20. The communication housing 401 is thus called “frontal housing.”

The printed circuit board 32 comprises a third connection zone 34C, which comprises several juxtaposed electrical contact pads 36. The third connection zone 34C here comprises five aligned contact pads 36. The third connection zone 34C is located in the connection housing 401, the printed circuit board 32 here forming a bottom of the connection housing 401.

Each contact pad 36 of the connection zone 34C is located recessed from the front plane P22 and is spaced away from the front plane P22 by a distance, measured according to the depth axis, greater than the first threshold S1.

The third communication module 400 is now described.

The communication module 400 is configured to be received in the communication housing 401 in an assembled position of the communication module 400, the control unit 20 being then in an assembled configuration. The communication module 400 comprises a body 410, which is made of an electrically insulating material.

The body 410 is represented in isolation in FIG. 3, and in an assembled configuration in FIG. 2. With reference to FIG. 9 where the body 410 is visible in section, the body 410 comprises a main portion delimiting a cavity 411, which is open according to a rear direction of the body 410, the rear direction being opposite to the forward direction D22 when the communication module 400 is assembled to the casing 30. The body 410 here presents a constant section and extends parallel to the transverse axis T214. The body 410 thus comprises a front wall 411A, which is located on the user side when the connection module 300 is in the assembled position, two lateral walls 411C, which extend orthogonally to the transverse axis T214, and which are connected to each other by the front wall 411A. The body 410 thus comprises an upper wall 411D and a lower wall 411E, which are parallel to each other, and which are connected to each other, on the one hand, by the front wall 411A and, on the other hand, by the lateral walls 411D. The front wall 411A, the lateral walls 411C, the upper wall 411D, and the lower wall 411E together form an envelope that delimits the cavity 411. The front wall 411A forms a proximal wall of this envelope, while the lateral walls 411C, the upper wall 411D, and the lower wall 411E together form a peripheral wall of the envelope. The cavity 411 opens from the envelope of the third communication module 400 through a distal opening 418.

The body 410 also comprises attachment means 412 to hold the communication module 400 in the assembled position. The attachment means 412 are here two elastic clips, which extend here toward the rear from each of the lateral faces 411C. The attachment means 412 are advantageously reversible, so that a user can extract the communication module 400 from the communication housing 401, for example to replace the communication module 400 in case of malfunction.

Advantageously, the front wall 411A is located recessed from the front plane P22, while the body 410 also comprises a projection 413A, which extends from the front wall 411A according to the forward direction D22, the front wall 411A and the projection together delimiting a recess 413B of the body 410, and by extension of the third communication module 400. The recess 413B is thus located recessed from the front plane.

The projection 413A here presents, in cross-section, a continuous L-shaped profile. The projection 413A is located at a distance from an edge of the junction between the front wall 411A and the upper wall 411D, so that the recess 413B is open both toward the front and toward the top of the control unit 20 when the body 410 is in the assembled position.

When the control unit 20 is received in the receptacle of the breaker unit 16 and the cover 18 is mounted on the breaker unit, the cover 18 covers the recess 413B, so as to prevent the removal of the communication module, as illustrated in FIG. 10. More precisely, an edge 19A of the window 19 of the cover 18 cooperates with the recess 413B, so as to limit the movements of the body 410 relative to the casing 30 of the control unit, in particular the movements in translation toward the front or toward the top. The communication module 400 is thus held assembled to the housing 30.

It is thus understood that when the control unit 20 is received in the receptacle of the breaker unit 16, as long as the cover 18 is assembled to the breaker unit 16, the cover prevents both the removal of the communication module 400 from the control unit 20, and the removal of the control unit 20 from the breaker unit 16.

The cavity 411 is configured to receive a communication card 414. With reference to FIG. 3, the communication card 414 comprises an antenna 416, and several examples of complementary contacts 220. The complementary contacts 220 are here pins 415, preferably telescopic pins—also called “pogo-pins”, each pin 415 being configured to be connected to a respective contact pad 36 according to a movement in translation.

The telescopic pins 315 allow dimensional variations to be accommodated when the communication module 400 is in the assembled position. This reduces the footprint of the control unit 20, while ensuring good electrical contact between the input connector 314 and the associated contact pads 36.

When the communication card 414 is received in the cavity 411, the antenna 416 is advantageously located facing the front wall 411A.

When the functional module is received in the corresponding housing, the envelope at least partially closes the associated housing, so that a creepage distance from each contact pad to the front plane is greater than a class 2 isolation distance under a voltage greater than 690 V, the creepage distance being according to the IEC 947-1:2019 standard. The class 2 isolation distance is obtained both when the communication card is present and when the communication card is absent. It is thus possible to add the communication card, according to user needs, even after the commissioning of the control module 20 and the circuit breaker 10, without changing the safety level of the circuit breaker 10.

In the illustrated example, the battery housing 201 is delimited by the bottom wall 204, while the printed circuit board 32 is located on the rear side of the bottom wall 204. Similarly, the connection housing 301 is delimited by the corresponding bottom wall 304, the printed circuit board 32 being also located on the rear side of the bottom wall 304 delimiting the connection housing 301.

More generally, the casing 30 advantageously comprises an intermediate wall 38, which is generally parallel to the front plane P22, and which is provided recessed from the front plane P22, the printed circuit board 32 being located on the rear side of the intermediate wall 38. The bottom wall 204 delimiting the battery housing 201 and the bottom wall 304 delimiting the connection housing 301 are advantageously portions of the intermediate wall 38. When it is necessary to provide an opening through a portion of the intermediate wall 38 to connect a functional module to a connection zone provided on the printed circuit board, this portion of the intermediate wall 38 is preferably located recessed from the front plane P22 and is spaced away from the front plane by a distance, measured according to the depth axis, greater than the predetermined first threshold. This ensures a sufficient isolation distance between the connection zone and the user.

In the illustrated example, the control unit 20 comprises three functional modules 99, which include the wired connection module 200, the battery module 300, and the wireless communication module 400. The principles of the invention can naturally be transposed to other types of functional modules 99, which are each associated with a respective housing. Each functional module is preferably chosen from a list including a battery module, a wireless communication module, and a wired connection module.

The embodiments and alternatives mentioned above can be combined with each other to generate new embodiments of the invention.

1. A control unit for an electrical circuit breaker, the control unit comprising:
a front face, which presents a generally flat shape and is geometrically carried by a front plane, the front face being orthogonal to a depth axis and defining a forward direction oriented toward the user when the control unit is in a normal use configuration,
a casing, which is made of an insulating material and wherein at least one housing is provided, each housing being provided recessed from the front plane and opening onto the front face,
a printed circuit board, which comprises at least one connection zone, each connection zone comprising one or more electrical contact pads and being associated with a respective housing,
at least one functional module, each housing being associated with a respective functional module, each functional module comprising an envelope, which is made of an electrically insulating material and which delimits a cavity, each functional module being configured to be reversibly received in the associated housing, the functional module being in an assembled configuration,
wherein, for each housing:
each contact pad of the associated connection zone is located recessed from the front plane and is spaced away from the front plane by a distance, measured according to the depth axis, greater than a predetermined first threshold,
the first threshold is chosen so that a clearance distance between each contact pad and the front plane is greater than a class 2 isolation distance under a voltage greater than 690 V, the clearance distance and the class 2 isolation distance being according to the IEC947-1:2019 standard, and
when the functional module is received in the corresponding housing, the envelope at least partially closes the associated housing, so that a creepage distance between each contact pad and the front plane is greater than a class 1 isolation distance under a voltage less than 690 V, the creepage distance being according to the IEC947-1:2019 standard.

2. The control unit according to claim 1, wherein:
the first threshold is greater than or equal to 14 mm.

3. The control unit according to claim 1, wherein:
each envelope comprises a proximal wall, which is generally orthogonal to a main axis, and a peripheral wall, which extends in projection from the proximal wall and which presents a continuous contour around the main axis, the proximal wall and the peripheral wall together delimiting the cavity of the envelope, the cavity opening from the envelope through a distal opening, which is located opposite the proximal wall according to the main axis,
when the functional module is in an assembled configuration:
the main axis is parallel to the depth axis, while the distal opening is oriented toward the corresponding connection zone, the cavity masking the contact pads according to the depth axis,
a creepage distance from each contact pad to the front plane is greater than a predetermined second threshold, the second threshold being greater than the first threshold.

4. The control unit according to claim 3, wherein:
the second threshold is greater than a class 2 isolation distance under a voltage greater than 690 V such as defined in the IEC 947-1:2019 standard.

5. The control unit according to claim 3, wherein:
the second threshold is equal to 20 mm.

6. The control unit according to claim 1, wherein:
the at least one housing is delimited, on the rear side, by a bottom wall, which is part of the casing, which is arranged recessed from the front plane according to the forward direction and wherein openings are provided, the openings opening into the housing,
the contact pads of the connection zone associated with the housing are located on a rear side of the bottom wall and are accessible from the housing through the openings.

7. The control unit according to claim 6, wherein:
each opening presents a profile with an inscribed circle diameter strictly less than 4 mm, in order to comply with an IP2x protection index as defined in the IEC 60529:2013 standard.

8. The control unit according to claim 6, wherein:
the casing comprises an intermediate wall, which is generally parallel to the front plane, and which is provided recessed from the front plane, the printed circuit board being located on a rear side of the intermediate wall,
for the at least one housing, the corresponding bottom wall is a portion of the intermediate wall.

9. The control unit according to claim 1, wherein:
each functional module comprises at least one complementary contact, which is made of metal, which is partially received in the corresponding cavity and which protrudes outside the cavity,
each complementary contact is configured to be reversibly connected to a respective electrical contact pad associated with the corresponding housing when the functional module is in an assembled configuration.

10. The control unit according to claim 9, wherein:
each functional module is chosen from a list including a battery module, a wireless communication module, and a wired connection module.

11. The control unit according to claim 10, wherein:
the control unit comprises three functional modules, which are each associated with a respective housing,
the three functional modules are different from each other and include a battery module, a wireless communication module, and a wired connection module.

12. An electrical circuit breaker, comprising:
a breaker unit, comprising at least one breaker device and an actuator, the breaker device being triggerable by means of the actuator,
one example of the control unit according to claim 1,
wherein:
the breaker unit provides a receptacle, which opens onto a frontal face of the breaker unit,
the control unit is received in the receptacle of the breaker unit so that the front face of the control unit is aligned with the frontal face of the breaker unit.

13. The electrical circuit breaker according to claim 12, wherein:
the circuit breaker comprises a cover, which is reversibly fixed on the breaker unit, which is made of an electrically insulating material, which extends generally according to a frontal plane, and which delimits a portion of the frontal face,
the at least one control unit housing includes a frontal housing, which is arranged at the edge of the front face, while the corresponding functional module envelope presents a recess, which is located recessed from the front plane,
when the control unit is received in the receptacle of the breaker unit and the cover is mounted on the breaker unit, the cover at least partially covers the recess, so as to prevent the removal of the functional module associated with the frontal housing.
